(19) United States
(12) Patent Application Publication
(10) Pub. No.: US 2010/0023989 A1
(43) Pub. Date: Jan. 28, 2010

(54) RELAY DEVICE, RELAY METHOD, AND PROGRAM

(76) Inventor: MASAO SHIMADA, Tokyo (JP)

Correspondence Address: Mr. Jackson Chen, 6535 N. STATE HWY 161, IRVING, TX, 75039, US

(21) Appl. No.: 12/507,425

(22) Filed: Jul. 22, 2009

(30) Foreign Application Priority Data
Jul. 25, 2008 (JP) 2008-191986

(51) Int. Cl. H04N 7/173; H04B 3/36

(52) U.S. Cl. 725/114; 340/425.1

(57) ABSTRACT

When a relay device receives a content transmitted from a first communication device toward a second communication device, the relay device performs relay processing of transmitting the content toward the second communication device. When, during the relay processing, the relay device receives a transmission request for the content, which has been transmitted from a third communication device toward the first communication device, the relay device performs transmission processing of transmitting a first section of the content, which has not been transmitted in the relay processing at a time of reception of the transmission request, from the relay device toward the third communication device in synchronization with transmission of the first section performed in the relay processing.

### BACKGROUND OF THE INVENTION

1. Field of the Invention

The present invention relates to a relay device, a relay method, and a program, and more particularly, to a relay device, a relay method, and a program, which are capable of transmitting the same data toward a plurality of transmission destinations.

2. Description of the Related Art

In JP 11-098162 A, there is described a relay device provided with a cache function. The relay device relays data and stores the relayed data for a given period of time. Then, the relay device receives a transmission request for the relayed data, which has been transmitted from a transmission source of the transmission request toward a transmission source of the relayed data. Subsequently, the relay device transmits the relayed data stored therein to the transmission source of the transmission request in place of the transmission source of the relayed data.

Further, in JP 2002-026942 A, there is described a client computer that stores moving picture contents distributed from a distribution server. The client computer distributes, upon reception of a distribution request for the moving picture contents stored therein, the moving picture contents to a transmission source of the distribution request in place of the distribution server.

The relay device described in JP 11-098162 A relays contents such as data, and at the same time, stores the contents therein. After that, upon reception of a transmission request for the contents, the relay device transmits the contents stored therein to a communication device that is a transmission source of the transmission request.

Accordingly, when the relay device receives the transmission request for the contents while relaying the contents, the contents are transmitted to the transmission source of the transmission request after the relay device has completed relaying and storing the contents.

Thus, this relay device has a problem that, when the relay device receives a transmission request for contents while relaying the contents, it takes longer for the relay device to actually start transmitting the contents after the reception of the transmission request.

The client computer described in JP 2002-026942 A is not a relay device, but stores moving picture contents or contents such as data therein, to thereby transmit the contents stored therein to another communication device.

Accordingly, for example, even if the technology described in JP 2002-026942 A is applied to the relay device described in JP 11-098162 A, the relay device described in JP 11-098162 A, to which the technology described in JP 2002-026942 A is applied, (hereinbelow, referred to as “particular relay device”) transmits, when the particular relay device receives a transmission request for contents while relaying the contents, the contents to a transmission source of the transmission request after completion of relaying and storing the contents.

Therefore, the particular relay device has a problem that, when the particular relay device receives a transmission request for contents while relaying the contents, it takes longer for the particular relay device to actually start transmitting the contents after the reception of the transmission request.

### SUMMARY OF THE INVENTION

An object of the present invention is to provide a relay device, a relay method, and a program, which make it possible to solve the above-mentioned problems.

According to one aspect of the present invention, a relay device includes: connection unit that connects to a first communication device, a second communication device, and a third communication device; and control unit that controls via the connection means, communication with the first communication device, the second communication device, and the third communication device. The control unit is configured to: when the connection unit receives a content transmitted from the first communication device toward the second communication device, perform relay processing of transmitting the content from the connection means toward the second communication device; when, during the relay processing, the connection unit receives a transmission request for the content, which has been transmitted from the third communication device, perform transmission processing of transmitting a first section of the content, which has not been transmitted in the relay processing at a time of reception of the transmission request, from the connection unit toward the third communication device in synchronization with transmission of the first section performed in the relay processing.

According to another aspect of the present invention, a relay method used for a relay device connected to a first communication device, a second communication device, and a third communication device, includes: performing relay processing of transmitting, upon reception of a content transmitted from the first communication device toward the second communication device, the content toward the second communication device;

performing transmission processing of transmitting, during the relay processing, upon reception of a transmission request for the content, which has been transmitted from the third communication device, a first section of the content, which has not been transmitted in the relay processing at a time of the reception of the transmission request, toward the third communication device in synchronization with transmission of the first section performed in the relay processing.

According to still another aspect of the present invention, a program causes a computer connected to a first communication device, a second communication device, and a third communication device to execute: a relay step of transmitting, upon reception of a content transmitted from the first communication device toward the second communication device, the content toward the second communication device; a transmission step of transmitting, during the relay step, upon reception of a transmission request for the content, which has been transmitted from the third communication device toward the first communication device, a first section of the content, which has not been transmitted in the relay step at a time of the reception of the transmission request, toward the third communication device in synchronization with transmission of the first section performed in the relay step.

According to the present invention, when the transmission request for the content is received in the course of relaying the content, it is possible to reduce the period of time required for actually starting transmission of the content after the reception of the transmission request.

### BRIEF DESCRIPTION OF THE DRAWINGS

In the accompanying drawings:

FIG. 1 is a configuration diagram illustrating a file transfer system including a relay device according to one embodiment of the present invention;

FIG. 2 is a structure diagram of an MPEG file;

FIG. 3 is a conceptual diagram illustrating logical connection among transmission devices and reception devices;

FIG. 4 is an explanatory diagram illustrating a packet structure of a network protocol;

FIG. 5 is an explanatory diagram illustrating a structure of an IP packet, particularly, a structure of an IP header;

FIG. 6 is an explanatory diagram illustrating a structure of a UDP packet;

FIG. 7 is an explanatory diagram illustrating a structure of an FIP packet;

FIG. 8 is an explanatory diagram for describing commands (FIP_CMDs) each identified by a command number within the FIP packet;

FIG. 9 is a block diagram of the transmission device;

FIG. 10 is a block diagram of the relay device;

FIG. 11 is a block diagram of the reception device;

FIG. 12 is a flow chart for describing a flow of processing performed by the relay device; and

FIG. 13 is an explanatory diagram illustrating an example of a list within a RAM.

### DETAILED DESCRIPTION OF THE PREFERRED EMBODIMENT

Hereinbelow, referring to the attached drawings, description is made of a relay device according to an embodiment of the present invention.

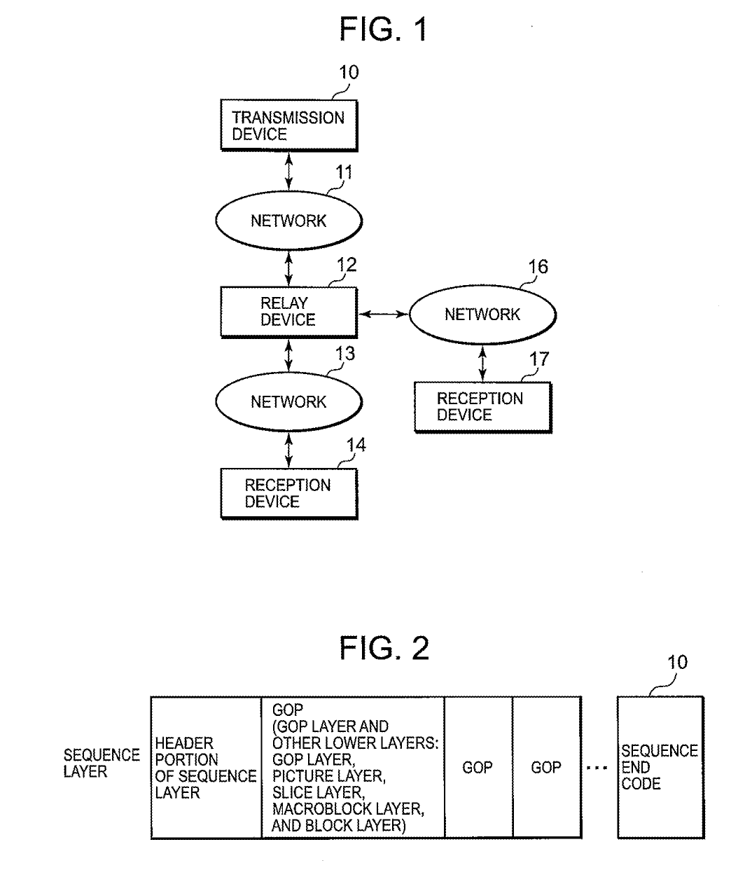

FIG. 1 is a configuration diagram illustrating a file transfer system including the relay device according to the embodiment of the present invention.

In FIG. 1, a transmission device 10 and a relay device 12 are connected to a network 11. The relay device 12 and a reception device 14 are connected to a network 13. The relay device 12 and a reception device 17 are connected to a network 16.

The transmission device 10 stores contents. According to this embodiment, Moving Picture Experts Group (MPEG) video data (hereinbelow, referred to as “MPEGfile” or simply as “file”) is used as the contents. However, the contents are not limited to the MPEG video data.

The relay device 12 relays file communication between the transmission device 10 and the reception device 14. Further, the relay device 12 relays file communication between the transmission device 10 and the reception device 17.

A file stored in the transmission device 10 is transmitted from the transmission device 10, and is then received by the reception device 14 via the network 11, the relay device 12, and the network 13.

Further, a file stored in the transmission device 10 is transmitted from the transmission device 10, and is then received by the reception device 17 via the network 11, the relay device 12, and the network 16.

FIG. 2 is a structure diagram of an MPEG file.

The MPEG file has a hierarchical structure that includes a sequence layer, a group of pictures (GOP) layer, a picture layer, a slice layer, a macroblock layer, and a block layer.

The sequence layer, the GOP layer, the picture layer, the slice layer, the macroblock layer, and the block layer each includes a header portion.

For example, the sequence layer at the top level includes a header portion of the sequence layer and a plurality of GOPs (see FIG. 2). In the header portion of the sequence layer, information for play the plurality of GOPs following the header portion of the sequence layer is written. It should be noted that there is a case in which only one GOP is provided.

In this embodiment, the GOP represents a GOP layer and other layers below the GOP layer.

When one whole MPEG file is transmitted, the transmission device 10 first transmits the header portion of the sequence layer of the MPEG file by means of one or a plurality of packets. Next, the transmission device 10 transmits a plurality of GOPs following the header portion of the sequence layer one by one in order by means of a plurality of packets.

Accordingly, first, the relay device 12 receives the header portion of the sequence layer of the MPEG file transmitted from the transmission device 10. Next, the relay device 12 transmits the header portion of the sequence layer toward a reception device (for example, the reception device 17). Then, the relay device 12 receives the plurality of GOPs of the MPEG file one by one in order. Subsequently, the relay device 12 transmits the GOPs toward the reception device (for example, the reception device 17). It should be noted that the relay device 12 stores the header portion of the sequence layer until the relay of the MPEG file is completed.

The transmission device 10 may generally be referred to as a first communication device. The reception device 14 may generally be referred to as a second communication device. The reception device 17 may generally be referred to as a third communication device.

The reception device 14 may also serve as the reception device 17. In this case, it is only necessary that the relay device 12 be connected to at least two communication devices.

Furthermore, the relay device may be connected to another transmission device which has the same content as the transmission device 10. In this case, the reception device 17 may transmit a transmission request toward the transmission device 10 or another transmission device. In addition, the relay device may request a second section of the content toward the transmission device 10 or another transmission.

The relay device 12 receives, for example, a file having a file identifier (ID) of “x” (hereinbelow, referred to as “file x”), which has been transmitted from the transmission device 10 toward the reception device 14, and then performs relay processing of transmitting the file x toward the reception device 14.

While performing the relay processing, the relay device 12 receives a transmission request for the file x (hereinbelow, simply referred to as “transmission request”), which has been transmitted from the reception device 17 toward the transmission device 10. Next, the relay device 12 performs transmission processing. Specifically, of the file x that is being transmitted in the relay processing, the relay device 12 transmits, toward the reception device 17, a whole or part of a section that has not been transmitted toward the reception device 14 in the relay processing at the time of reception of the transmission request, in synchronization with the transmission of the whole or part of the section toward the reception device 14.

Here, of the file x that is being transmitted in the relay processing, the whole or part of the section that has not been transmitted toward the reception device 14 in the relay processing at the time of reception of the transmission request may generally be referred to as a first section of the file x. Hereinbelow, the first section of the file x may also be referred to simply as a “first section”.

The relay device 12 transmits, toward the transmission device 10, a partial-transmission request indicating that the reception device 17 is requesting a section (second section) of the file x, which has not been transmitted toward the reception device 17 in the transmission processing at the time of completion of the transmission processing.

It should be noted that, while performing the relay processing, the relay device 12 stores the header portion of the sequence layer of the file x, which is MPEG video data.

In this embodiment, when the relay device 12 receives, during the relay processing, a transmission request transmitted from the reception device 17, the relay device 12 transmits the stored header portion of the sequence layer toward the reception device 17. Then, the relay device 12 transmits, toward the reception device 17, a GOP (first section) that, of the file x that is being transmitted in the relay processing, has not been transmitted in the relay processing at the time of reception of the transmission request in synchronization with the transmission of the GOP performed in the relay processing.

After that, that is, after the relay processing and the transmission processing are completed, the relay device 12 performs request processing. Specifically, as the partial-transmission request, the relay device 12 transmits, toward the transmission device 10, a partial-data transmission request indicating that the reception device 17 is requesting a GOP (second section) of the file x, which has not been transmitted toward the reception device 17 in the transmission processing.

After both the relay processing and the transmission processing are completed, the relay device 12 deletes the stored header portion of the sequence layer.

In many cases, as for MPEG file data located in the GOP layer and other lower layers, or a file in another format used as contents, the relay device 12 does not need to store such data or file therein beyond the total number of payload octets to be transmitted by the relay device 12 in one transmission.

In a case where the relay device 12 operates at the Data Link Layer and communicates through Ethernet, the size of the MPEG file data located in the GOP layer and other lower layers or the size of the file in another format, which the relay device 12 is required to store, is equal to or less than 1,500 octets,which is a maximum value for a payload amount under the standards of Ethernet.

In a case where the relay device 12 communicates via a fiber distributed data interface (FDDI), the size of the MPEG file data located in the GOP layer and other lower layers or the size of the file in another format, which the relay device 12 is required to store, is 4,500 octets.

When the relay device 12 receives a packet containing the GOP layer and other lower layers such as the Data Link Layer or the Network Layer, the relay device 12 temporarily stores the packet in a memory or the like, and then transmits the stored data toward reception devices (for example, the reception device 14 and the reception device 17) in order or through time-division multiplexing.

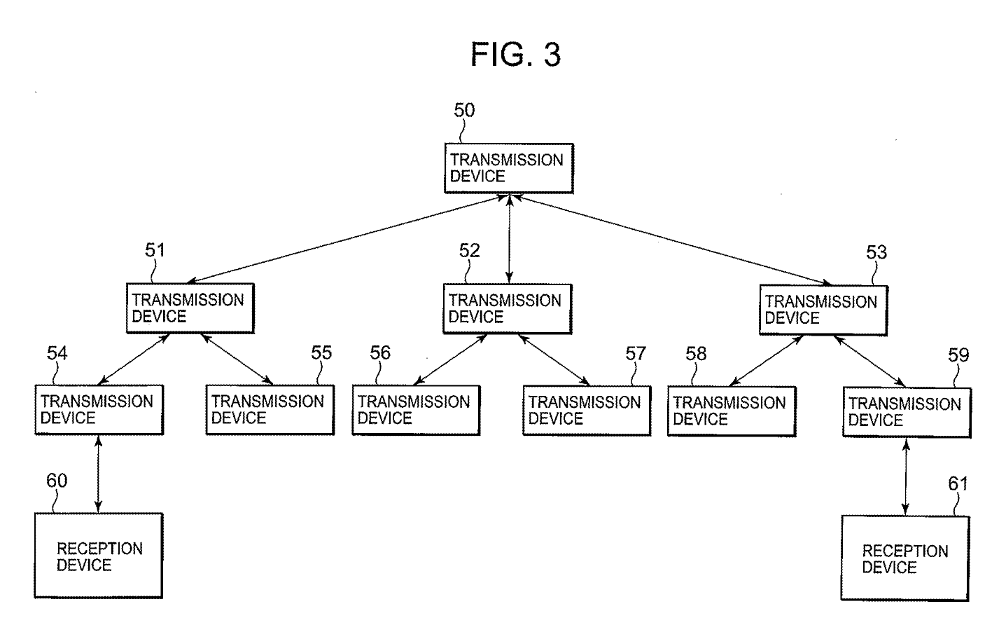

FIG. 3 is a conceptual diagram illustrating logical connection among transmission devices and reception devices.

In FIG. 3, a transmission device 50 is connected to a transmission device 51, a transmission device 52, and a transmission device 53. The transmission device 51 is further connected to a transmission device 54 and a transmission device 55. The transmission device 52 is further connected to a transmission device 56 and a transmission device 57. The transmission device 53 is further connected to a transmission device 58 and a transmission device 59.

The transmission devices 50 to 59 are connected in a tree structure. The transmission device 50 is located at the top of the tree structure, and manages a file ID.

Upon reception of a file ID acquisition request transmitted toward the transmission device 50 from a transmission device below, the transmission device 50 issues a file ID to a transmission source of the file ID acquisition request.

The transmission device that has issued the file ID acquisition request stores a file and the acquired file ID in association with each other.

The file ID may be a serial number, or may be a combination of a serial number and a MAC address of a device that has issued the file ID acquisition request.

The file and the file ID are attached to an e-mail, and are then transmitted toward another transmission device or copied to another transmission device by means of such a medium as a digital versatile disk (DVD) or a compact disk (CD). Accordingly, a plurality of transmission devices stores the same file and the same file ID.

In this embodiment, the transmission device 54 and the transmission device 59 store the same file and the file ID thereof.

In FIG. 3, the transmission device 10 illustrated in FIG. 1 corresponds to the transmission device 54. The reception device 14 illustrated in FIG. 1 corresponds to a reception device 60.The reception device 17 illustrated in FIG. 1 corresponds to a reception device 61.

With operation of the relay device 12 (not shown in FIG. 3), the transmission device 54, the reception device 60, the transmission device 59, and the reception device 61 operate in the following manner, for example.

A file that has been transmitted from the transmission device 54 is received by the reception device 60. It should be noted that the file is communicated using a plurality of packets.

When the reception device 61 makes a request for the same file as the file that is being received by the reception device 60 while the file transmitted from the transmission device 54 is being received by the reception device 60, a whole or part of the file transmitted from the transmission device 54 is received by the reception device 60 and the reception device 61.

In addition, of the file requested by the reception device 61, a section that has not been transmitted from the transmission device 54 to the reception device 61 is transmitted from, for example, the transmission device 59, and is then received by the reception device 61.

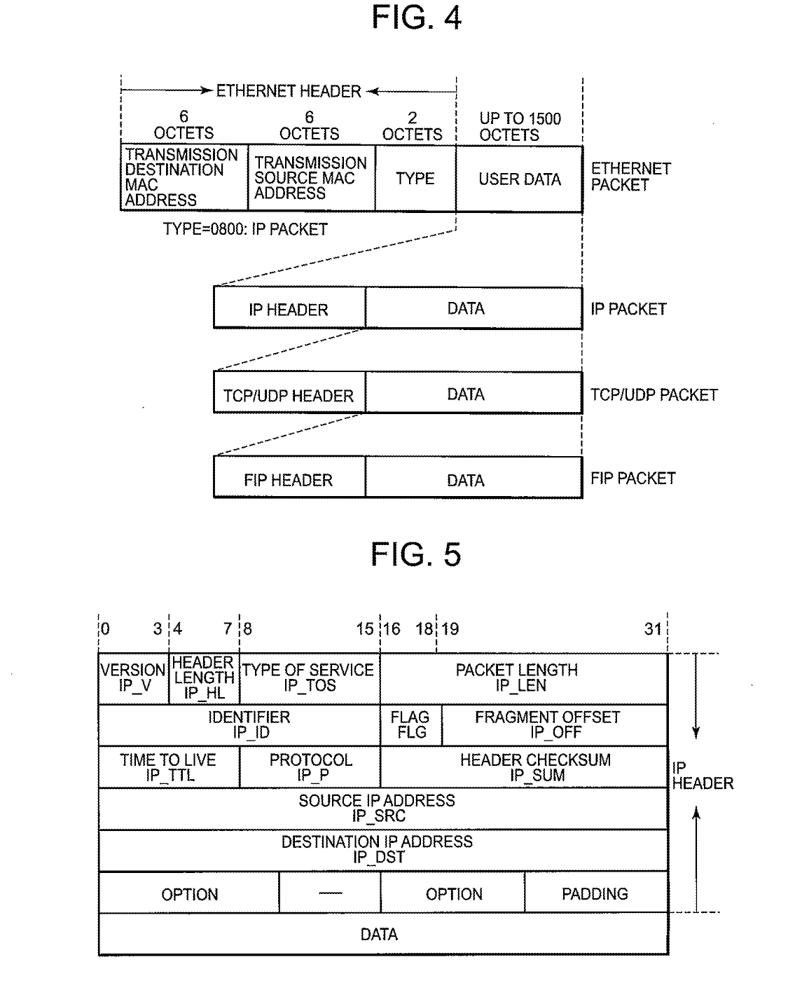

FIG. 4 is an explanatory diagram illustrating a packet structure of a network protocol used in this embodiment. It should be noted that Ethernet packets are used in this embodiment.

An Ethernet packet includes an Ethernet header and data (user data).

The Ethernet header of the Ethernet packet includes a transmission destination media access control (MAC) address, a transmission source MAC address, and a type.

A data section of the Ethernet packet includes an Internet Protocol (IP) header and data of an IP packet.

The data of the IP packet includes a Transmission Control Protocol/User Datagram Protocol (TCP/UDP) header and data of a TCP/UDP packet.

The data of the TCP/UDP packet includes a File Interrupt Protocol (FIP) header and data of an FIP packet. It should be noted that the FIP is an original protocol.

FIG. 5 is an explanatory diagram illustrating a structure of the IP packet, particularly, a structure of the IP header.

The IP header includes a version, a header length, a type of service, a packet length, an identifier, a flag, a fragment offset, a time-to-live, a protocol number, a header checksum, a source IP address, and a destination IP address.

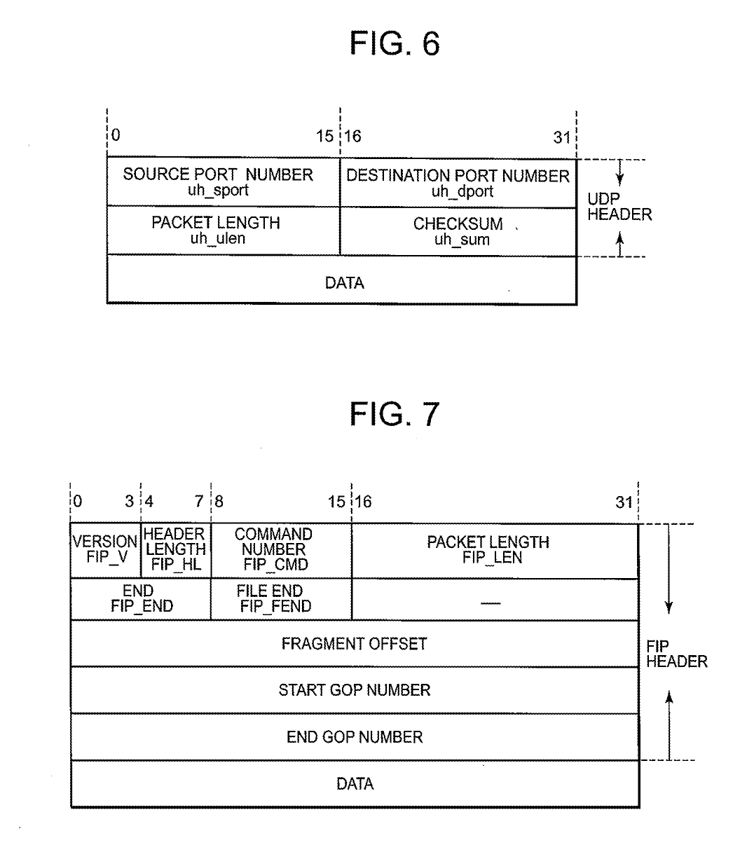

FIG. 6 is an explanatory diagram illustrating a structure of a UDP packet.

The UDP packet includes a source port number, a destination port number, a packet length, a checksum, and data.

A transmission device for FIP uses a port number “65535” of TCP or UDP, whereas a reception device for FIP uses an unused port.

FIG. 7 is an explanatory diagram illustrating a structure of the FIP packet.

The FIP packet includes a version, a header length, a command number, a packet length, an end, a file end, a fragment offset, a start GOP number, an end GOP number, and data.

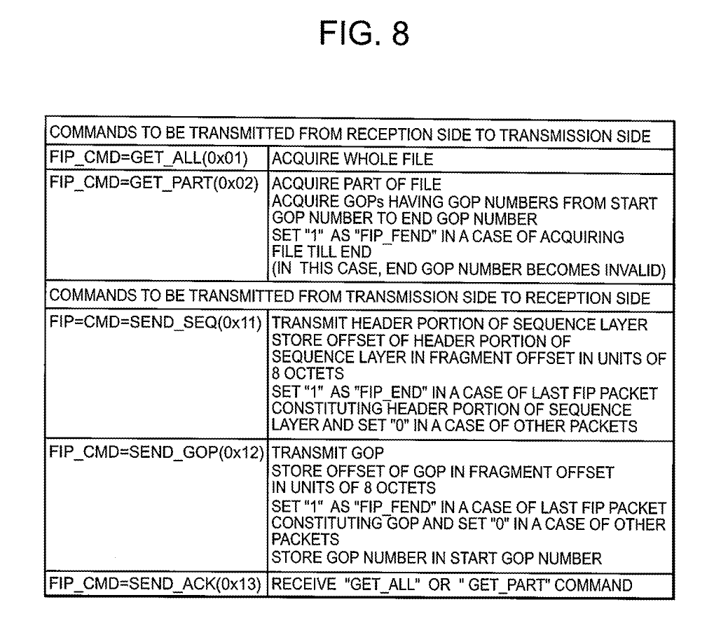

FIG. 8 is an explanatory diagram for describing commands (FIP_CMDs) each identified by a command number within the FIP packet.

In the FIP packet, GET_ALL(0x01), GET_PART(0x02), SEND_SEQ(0x 11), SEND_GOP(0x12), and SEND_ACK(0x13) are used as the commands.

FIP_CMD=GET_ALL(0x01) is a command to request acquisition of a whole file. In FIP packet data having GET_ALL(0x01) written therein, for example, the file ID is written.

FIP_CMD=GET_PART(0x02) is a command to request acquisition of part of a file. FIP_CMD=GET_PART(0x02) is used to acquire GOPs (data) identified by GOP numbers from the start GOP number to the end GOP number specified in the FIP header. In FIP packet data having GET_PART(0x02) written therein, for example, the file ID is written.

GET_ALL(0x01) and GET_PART(0x02) are transmitted to the transmission device 10 from the reception device 14, the reception device 17, or the relay device 12.

An FIP packet having GET_ALL(0x01) written therein, in other words, an Ethernet packet that contains an FIP packet having GET_ALL(0x01) written therein may generally be referred to as a transmission request.

Further, an FIP packet having GET_PART(0x02) written therein, in other words, an Ethernet packet that contains an FIP packet having GET_PART(0x02) written therein may generally be referred to as a partial-transmission request or a partial-data transmission request.

FIP_CMD=SEND_SEQ(0x11) is a command to transmit the header portion of the sequence layer.

In an FIP packet having SEND_SEQ(0x11) written therein, an offset of the header portion of the sequence layer is stored in the fragment offset in units of 8 octets.

Among the FIP packets having SEND_SEQ(0x11) written therein, the last FIP packet constituting the header portion of the sequence layer has FIP_END set to “1”. On the other hand, among the FIP packets having SEND_SEQ(0x11) written therein, the other FIP packets constituting the header portion of the sequence layer have FIP_END set to “0”.

FIP_CMD=SEND_GOP(0x12) is a command to transmit a GOP.

In an FIP packet having SEND_GOP(0x12) written therein, an offset of a GOP is stored in the fragment offset in units of 8 octets.

Among the FIP packets having SEND_GOP(0x12) written therein, the last FIP packet constituting the GOP has FIP_END set to “1”. On the other hand, among the FIP packets having SEND_GOP(0x12) written therein, the other FIP packets constituting the GOP have FIP_END set to “0”.

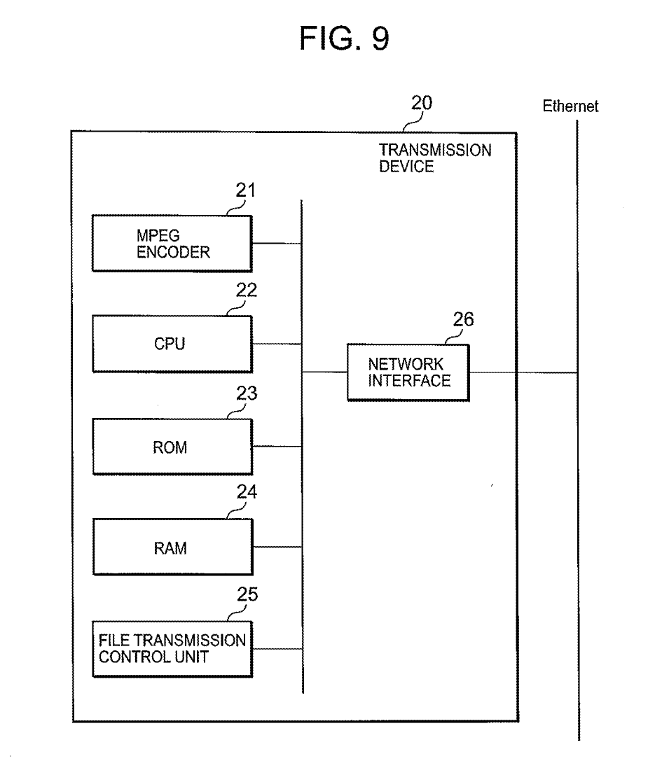

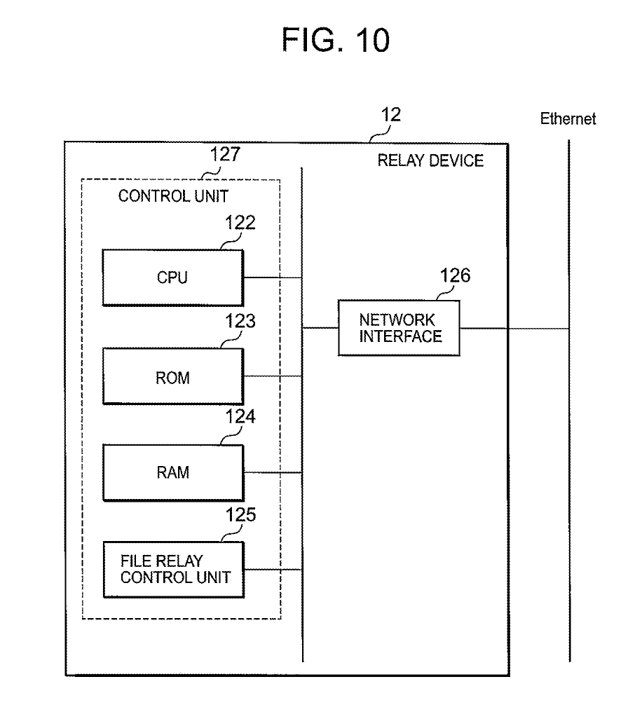

FIG. 9 is a block diagram of a transmission device. It should be noted that, in a transmission device 20 illustrated in FIG. 9, components common to the transmission devices illustrated in FIG. 1 and FIG. 3 are illustrated.

The transmission device 20 includes an MPEG encoder 21, a central processing unit (CPU) 22, a ROM (nonvolatile memory) 23, a RAM (volatile memory) 24, a file transmission control unit 25, and a network interface 26.

The MPEG encoder 21 creates an MPEG file, which serves as contents.

The file transmission control unit 25 transmits a file, and processes an FIP command.

The network interface 26 processes a network protocol to thereby connect to a network.

FIG. 10 is a block diagram of the relay device 12.

The relay device 12 includes a CPU 122, a ROM 123, a RAM 124, a file relay control unit 125, and a network interface 126. The RAM 124 may generally be referred to as storage means.

The file relay control unit 125 transmits/receives a file, and processes an FIP command.

The network interface 126 may generally be referred to as connection unit. The network interface 126 processes a network protocol to thereby connect to a network. The network interface 126 is connected to the transmission device 10, the reception device 14, and the reception device 17, which are illustrated in FIG. 1.

The CPU 122, the ROM 123, the RAM 124, and the file relay control unit 125 are included in a control unit 127.

The control unit 127 may generally be referred to as control unit.

For example, when the network interface 126 receives the file x that has been transmitted from the transmission device 10 toward the reception device 14, for example, the control unit 127 performs the relay processing of transmitting the file x from the network interface 126 toward the reception device 14.

While the control unit 127 is performing the relay processing, the network interface 126 receives a transmission request for the file x, which has been transmitted from the reception device 17 toward the transmission device 11. Next, the control unit 127 performs the transmission processing. Specifically, of the file x that is being transmitted in the relay processing, the control unit 127 transmits a whole or part of a section that has not been transmitted in the relay processing at the time of reception of the transmission request, that is, the first section, from the network interface 126 toward the reception device 17, in synchronization with the transmission of the first section performed in the relay processing.

The control unit 127 then performs the request processing. For example, the control unit 127 transmits a partial-transmission request indicating that the reception device 17 is requesting a section (second section) of the file x, which has not been transmitted in the transmission processing at the time of completion of the transmission processing, from the network interface 126 toward the transmission device 10.

Here, the control unit 127 uses an Ethernet packet, for example, a command within the FIP packet of the Ethernet packet to thereby perform the relay processing, the transmission processing, and the request processing. In addition, while performing the relay processing, the control unit 127 stores the header portion of the sequence layer of the file x in the RAM 124.

Further, when the network interface 126 receives the transmission request during the relay processing, the control unit 127 transmits data of the sequence layer stored in the RAM 124 from the network interface 126 toward the reception device 17. After that, the control unit 127 transmits GOPs that, of the file x that is being transmitted, have not been transmitted in the relay processing at the time of reception of the transmission request, from the network interface 126 toward the reception device 17 in synchronization with the transmission of the GOPs performed in the relay processing.

Further, for example, the control unit 127 creates, by using an FIP command, a partial-data transmission request indicating that the reception device 17 is requesting GOPs of the file x, which have not been transmitted in the transmission processing at the time of completion of the transmission processing. Next, the control unit 127 transmits the partial-data transmission request as a partial-transmission request from the network interface 126 toward the transmission device 10.

Further, upon completion of both the relay processing and the transmission processing, the control unit 127 deletes the header portion of the sequence layer stored in the RAM 124.

It should be noted that the relay device 12 may be implemented by, for example, a computer. In such a case, the relay device 12 operates in accordance with a program (application) recorded on a disk. The disk may generally be referred to as computer (relay device 12)-readable recording medium.

The relay device 12 reads the program from the disk (recording medium) and executes the program, thereby functioning as the network interface 126 and the control unit 127.

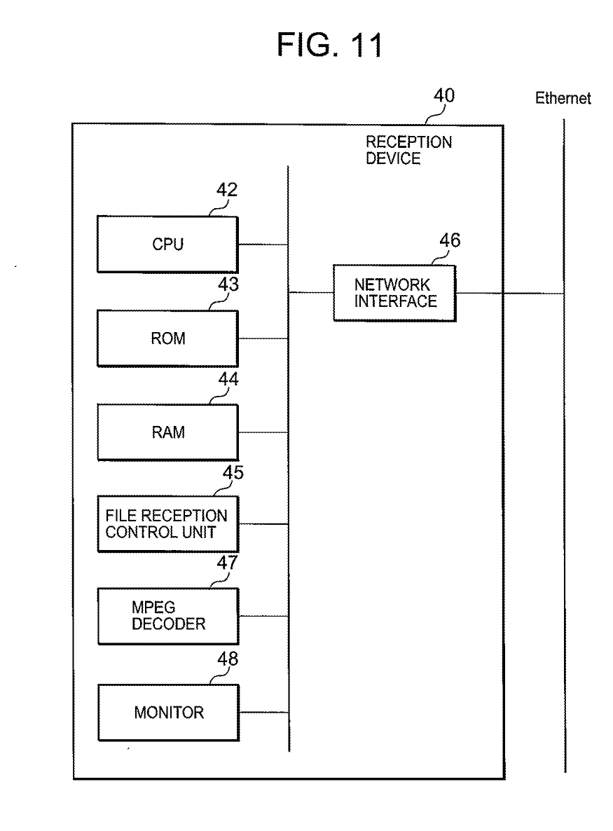

FIG. 11 is a block diagram of a reception device. It should be noted that, in a reception device 40 illustrated in FIG. 11, components common to the reception devices illustrated in FIG. 1 and FIG. 3 are illustrated.

The reception device 40 includes a CPU 42, a ROM 43, a RAM 44, a file reception control unit 45, a network interface 46, an MPEG decoder 47, and a monitor 48.

The file reception control unit 45 receives a file, and processes an FIP command. The network interface 46 processes a network protocol to thereby connect to a network. The MPEG decoder 47 decodes MPEG data. The monitor 48 displays a video according to a result of decoding the MPEG data.

Next, description is made of the operation of the relay device 12.

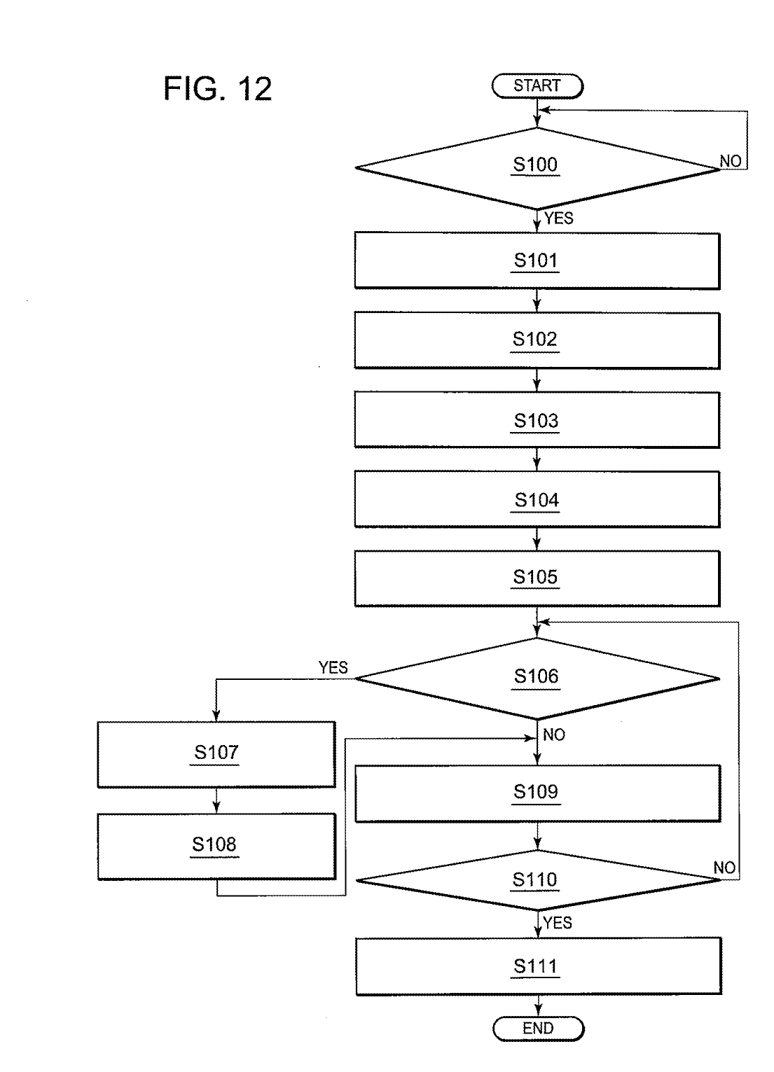

FIG. 12 is a flow chart for describing a flow of the processing performed by the relay device 12. It should be noted that the RAM 124 within the relay device 12 stores a list for managing the relay processing, the transmission processing, and the request processing.

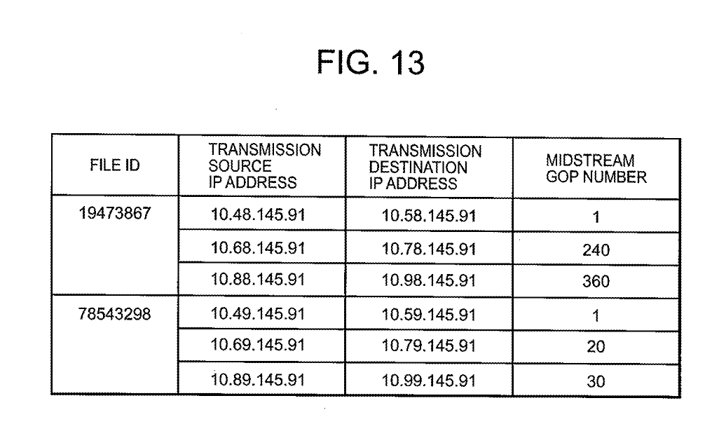

FIG. 13 is an explanatory diagram illustrating an example of the list within the RAM 124.

Referring to FIG. 13, in the list, there are written a file ID of a file that is being subjected to the relay processing, a transmission source IP address of the file, a transmission destination IP address of the file, and a midstream GOP number associated with the file. It should be noted that, as the midstream GOP number, the smallest number of the GOPs that have been transmitted to the transmission destination in the transmission processing is written.

Referring back to FIG. 12, first, the control unit 127 of the relay device 12 judges whether or not the relay device 12 has received a transmission request for a file (new file) associated with a file ID that is not written in the list (hereinbelow, referred to as “ID_X”) (Step S100).

Specifically, the control unit 127 judges whether or not the network interface 126 has received an Ethernet packet (hereinbelow, referred to as “new-file transmission request”) in which GET_ALL(0x1) is written and an ID_X that is not contained in the list is also written.

When the network interface 126 has not received a new-file transmission request, the control unit 127 returns the processing to Step S100.

On the other hand, when the network interface 126 has received a new-file transmission request, the control unit 127 writes, in the list, the ID_X written in the new-file transmission request (Step S101).

After writing the ID_X in the list, the control unit 127 refers to the new-file transmission request, and then adds, to the list, an IP address of a transmission source (transmission device) of the file associated with the ID_X and an IP address of a transmission destination (reception device) of the file, in association with the ID_X (Step S102).

Here, the control unit 127 adds, to the list, the IP address of the transmission destination of the new-file transmission request as the IP address of the transmission source (transmission device) of the file associated with the ID_X. The control unit 127 also adds, to the list, the IP address of the transmission source of the new-file transmission request as the IP address of the transmission destination (reception device) of the file associated with the ID_X.

After adding the transmission source IP address and the transmission destination IP address to the list, the control unit 127 transmits the new-file transmission request toward the transmission destination of the new-file transmission request (Step S103).

Upon reception of the new-file transmission request, the transmission destination (hereinbelow, referred to as “transmission device 1”) of the new-file transmission request transmits the file associated with the ID_X written in the new-file transmission request toward the transmission source (reception device) of the new-file transmission request by using Ethernet packets.

First, the transmission device 1 transmits the header portion of the sequence layer of the file, and subsequently transmits the GOPs one by one in order.

The relay device 12 starts receiving and transferring the file that has been transmitted from the transmission device 1 toward the reception device. Specifically, the control unit 127 starts receiving the header portion of the sequence layer of the file and transferring the header portion of the sequence layer of the file toward the reception device (relay processing) (Step S104).

The control unit 127 receives the whole header portion of the sequence layer of the file transmitted from the transmission device 1, and stores the whole header portion in the RAM 124 until one or a plurality of communications are all completed with respect to the file associated with the ID_X.

Further, after setting the value of a GOP counter provided in the RAM 124 to “1”, the control unit 127 adds the midstream GOP number (=1) to the list in association with the ID_X, the IP address of the transmission device 1, which is written as the transmission source IP address of the file associated with the ID_X, and the IP address of the transmission source (reception device) of the new-file transmission request, which is written as the transmission destination IP address of the file associated with the ID_X (Step S105).

Subsequently, the control unit 127 judges whether or not the network interface 126 has received a new transmission request for the file associated with the ID_X (another transmission request involving a different reception device or a different transmission device, compared to the devices used for the communication of the file associated with the ID_X written in the list) (Step S106).

When the network interface 126 has received a new transmission request for the file associated with the ID_X, the control unit 127 first refers to the new transmission request, and then adds, to the list, the IP address of the transmission source (transmission device) of the file associated with the ID_X and the IP address of the transmission destination (reception device) of the file, in association with the ID_X. Further, the control unit 127 adds, to the list, a current value of the GOP counter as a value of the midstream GOP number in association with the ID_X, an IP address of a newly-added transmission source (transmission device), and an IP address of a newly-added transmission destination (reception device) (Step S107).

After adding, to the list, the current value of the GOP counter as the value of the midstream GOP number in association with the ID_X, the control unit 127 transmits the header portion of the sequence layer of the file associated with the ID_X, which has been stored in the RAM 124, to a new transfer destination (transmission source of the new transmission request) (Step S108).

It should be noted that the control unit 127 executes the processing of Step S109 when a new transmission request for the file associated with the ID_X has not been received in Step S106 or when the header portion of the sequence layer of the file associated with the ID_X has been transmitted to the new transfer destination in Step S108.

In Step S109, every time the control unit 127 receives Ethernet packets for one GOP of the file associated with the ID_X, which have been transmitted from the transmission device 1, the control unit 127 refers to the list, and then transmits the Ethernet packets to all the transmission destinations (transmission destination IP addresses) of the ID_X, which are specified in the list. After the control unit 127 has received and transmitted all the Ethernet packets for one GOP, the control unit 127 increments the value of the GOP counter by one.

It should be noted that, in many cases, one GOP includes a plurality of FIP packets, but may include only one FIP packet.

The control unit 127 monitors intervals of arrival timing (hereinbelow, referred to as “FIP packet arrival intervals”) of a plurality of FIP packets that are transmitted from the transmission device 1 and arrive in the relay device 12 one after another.

When the FIP packet arrival interval is equal to or longer than a prescribed period of time set in advance, the control unit 127 judges that a path for the FIP packets from the transmission device 1 to the reception device is not stable, and that the FIP packets transmitted from the transmission device 1 toward the reception devices have ceased passing through the relay device 12.

Accordingly, when the FIP packet arrival interval is equal to or longer than the prescribed period of time set in advance, the control unit 127 refers to the list, and creates the following two partial-data transmission requests (GET_PART commands), which are then transmitted to the transmission source (for example, the transmission device 1 or another transmission device) of the file associated with the ID_X.

One partial-data transmission request is such a partial-transmission request that indicates that a transmission destination whose midstream GOP number in the list is not “1” is requesting GOP data having the GOP numbers from the current GOP number to the last GOP number of the file associated with the ID_X.

The other partial-data transmission request is such a partial-transmission request that indicates that a transmission destination associated with a particular midstream GOP number is requesting GOP data having the GOP numbers from the GOP number of “1” to the GOP number obtained by subtracting the particular midstream GOP number in the list by one.

Subsequently, in a case of communicating the file associated with the ID_X to a transmission destination whose midstream GOP number in the list is not “1”, the control unit 127 does not transmit GOPs having the GOP numbers thereof equal to or smaller than the current GOP number.

On the other hand, when the FIP packet arrival interval is shorter than the prescribed period of time set in advance, the control unit 127 judges whether or not the network interface 126 has received an FIP packet having the FIP_FEND set to “1”, that is, whether or not the network interface 126 has received the last FIP packet that constitutes the file (Step S110).

When the network interface 126 has not received an FIP packet having the FIP_FEND set to “1”, the control unit 127 returns the processing to Step S106.

When the network interface 126 has received an FIP packet having the FIP_FEND set to “1” in Step S110, the control unit 127 refers to the list, and then transmits a partial-transmission request (GET_PART command) indicating that all transmission destinations associated with the ID_X, whose midstream GOP numbers are not “1” are requesting GOP data having the GOP numbers from the start GOP number (=1) to the end GOP number (obtained by subtracting the midstream GOP number by one) to any one of the transmission sources associated with the ID_X (Step S111).

It should be noted that the GOP number starts from “1”.

Further, the control unit 127 counts GOP start codes contained in the MPEG file.

The list of FIG. 13 illustrates the following contents.

With regard to a file having the file ID of “19473867”, three types of communications have been carried out. In one communication, it is indicated that the file has been transmitted from the first GOP (GOP number=1). In another communication, it is indicated that the file has been transmitted from a GOP having the GOP number of “240”. Instill another communication, it is indicated that the file has been transmitted from a GOP having the GOP number of “360”. In many cases, one GOP has a length of 0.5 seconds.

With regard to a file having the file ID of “78543298”, three types of communications have been carried out. In one communication, it is indicated that the file has been transmitted from the first GOP (GOP number=1). In another communication, it is indicated that the file has been transmitted from a GOP having the GOP number of “20”. In still another communication, it is indicated that the file has been transmitted from a GOP having the GOP number of “30”.

According to this embodiment, the relay device 12 includes the control unit 127 that transmits, to a reception device that transmits a transfer request later, the whole or part of the file data to be transmitted to another reception device that transmits a transfer request earlier, when the relay device 12 receives transfer requests for files having the same file ID in time sequence. Further, the control unit 127 stores the header portion of the sequence layer of the MPEG file, which is a relay target, and transmits the stored header portion of the sequence layer to the reception device that requests the same file later.

Therefore, it is possible to spare a network band between the transmission device and the relay device, which, with the conventional art, would become necessary for a communication that occurs later.

According to this embodiment, while performing the relay processing of the file x (contents), the control unit 127 receives the transmission request for the file x, which has been transmitted from the reception device 17 toward the transmission device 11. Next, the control unit 127 performs the transmission processing. Specifically, the control unit 127 transmits, toward the reception device 17, the first section of the file x, which has not been transmitted in the relay processing at the time of reception of the transmission request, in synchronization with the transmission of the first section performed in the relay processing.

The control unit 127 then performs the request processing. Specifically, the control unit 127 transmits, toward the transmission device 10, the partial-transmission request indicating that the reception device 17 is requesting a section of the file x, which has not been transmitted in the transmission processing at the time of completion of the transmission processing.

Therefore, when the control unit 127 receives the transmission request for the file x while relaying the file x, it is possible for the control unit 127 to transmit the file x toward the transmission source of the transmission request as well while relaying the file x. In addition, the control unit 127 transmits, to a communication device having the file x, the partial-transmission request indicating that the transmission source of the transmission request is requesting a section of the file x, which has failed to be transmitted in synchronization with the relay.

Therefore, it is possible to reduce a period of time required for actually starting the transmission of contents after a transmission request is received.

According to this embodiment, the control unit 127 stores, in the RAM 124, the header portion of the sequence layer of the MPEG video data, which is the received contents.

When the control unit 127 receives the transmission request during the relay processing, the control unit 127 transmits the header portion of the sequence layer stored within the RAM 124 toward the transmission source of the transmission request. After that, the control unit 127 transmits, toward the transmission source of the transmission request, the first section of the contents that are being transmitted in the relay processing, in synchronization with the transmission of the first section performed in the relay processing.

In this case, with the use of the header portion of the sequence layer, the transmission source of the transmission request can carry out decoding from any part of the MPEG file.

According to this embodiment, after the completion of both the relay processing and the transmission processing, the control unit 127 deletes the header portion of the sequence layer stored within the RAM 124.

In this case, it is possible to prevent the RAM 124 from continuing to store the header portion of the sequence layer, which has become unnecessary.

According to this embodiment, in the transmission processing, the control unit 127 transmits, toward the transmission source of the transmission request, GOPs of the MPEG video data, which have not been transmitted in the relay processing at the time of reception of the transmission request, in synchronization with the transmission of the GOPs performed in the relay processing.

Further, in the request processing, the control unit 127 transmits the partial-data transmission request as the partial-transmission request toward the transmission source of the MPEG video data or the transmission destination of the transmission request. The partial-data transmission request indicates that the transmission source of the transmission request is requesting GOPs of the MPEG video data, which have not been transmitted in the transmission processing.

In this case, it is possible for the control unit 127 to perform the transmission processing and the request processing in units of GOPs.

The configuration illustrated in the drawings according to the above-mentioned embodiment is merely one example, and the present invention is not limited thereto.

What is claimed is:

1. A relay device, comprising:
connection unit that connects to a first communication device, a second communication device, and a third communication device; and
control unit that controls, via the connection means, communication with the first communication device, the second communication device, and the third communication device,
wherein the control unit is configured to:
when the connection unit receives a content transmitted from the first communication device toward the second communication device, perform relay processing of transmitting the content from the connection unit toward the second communication device;
when, during the relay processing, the connection unit receives a transmission request for the content, which has been transmitted from the third communication device, perform transmission processing of transmitting a first section of the content, which has not been transmitted in the relay processing at a time of reception of the transmission request, from the connection unit toward the third communication device in synchronization with transmission of the first section performed in the relay processing.

2. A relay device according to claim 1, wherein:
the control unit performs request processing of transmitting a partial-transmission request indicating that the third communication device is requesting a second section of the content, which has not been transmitted in the transmission processing at a time of completion of the transmission processing, from the connection unit toward the first communication device.

3. A relay device according to claim 1, wherein:
the content comprises MPEG video data;
the control unit comprises storage unit for storing a header portion of a sequence layer of the MPEG video data received by the connection unit; and
the control unit performs, as the transmission processing, processing of transmitting, when the connection unit receives the transmission request during the relay processing, the header portion of the sequence layer stored within the storage unit from the connection unit toward the third communication device, and subsequently transmitting the first section from the connection unit toward the third communication device in synchronization with the transmission of the first section performed in the relay processing.

4. A relay device according to claim 2, wherein:
the content comprises MPEG video data;
the control unit comprises storage unit for storing a header portion of a sequence layer of the MPEG video data received by the connection unit; and
the control unit performs, as the transmission processing, processing of transmitting, when the connection unit receives the transmission request during the relay processing, the header portion of the sequence layer stored within the storage unit from the connection unit toward the third communication device, and subsequently transmitting the first section from the connection unit toward the third communication device in synchronization with the transmission of the first section performed in the relay processing.

5. A relay device according to claim 3, wherein the control unit deletes the header portion of the sequence layer stored within the storage unit after completion of both the relay processing and the transmission processing.

6. A relay device according to claim 4, wherein the control unit deletes the header portion of the sequence layer stored within the storage unit after completion of both the relay processing and the transmission processing.

7. A relay device according to claim 3, wherein the control unit is configured to:
in the transmission processing, transmit a GOP of the MPEG video data, which has not been transmitted in the relay processing at the time of the reception of the transmission request, from the connection unit toward the third communication device in synchronization with transmission of the GOP performed in the relay processing; and
in the request processing, transmit, as the partial-transmission request, a partial-data transmission request indicating that the third communication device is requesting a GOP of the MPEG video data, which has not been transmitted in the transmission processing at the time of the completion of the transmission processing, from the connection unit toward the first communication device or another communication device.

8. A relay device according to claim 4, wherein the control unit is configured to:
in the transmission processing, transmit a GOP of the MPEG video data, which has not been transmitted in the relay processing at the time of the reception of the transmission request, from the connection unit toward the third communication device in synchronization with transmission of the GOP performed in the relay processing; and
in the request processing, transmit, as the partial-transmission request, a partial-data transmission request indicating that the third communication device is requesting a GOP of the MPEG video data, which has not been transmitted in the transmission processing at the time of the completion of the transmission processing, from the connection unit toward the first communication device or another communication device.

9. A relay device according to claim 5, wherein the control unit is configured to:
in the transmission processing, transmit a GOP of the MPEG video data, which has not been transmitted in the relay processing at the time of the reception of the transmission request, from the connection unit toward the third communication device in synchronization with transmission of the GOP performed in the relay processing; and
in the request processing, transmit, as the partial-transmission request, a partial-data transmission request indicating that the third communication device is requesting a GOP of the MPEG video data, which has not been transmitted in the transmission processing at the time of the completion of the transmission processing, from the connection unit toward the first communication device or another communication device.

10. A relay device according to claim 6, wherein the control unit is configured to:
in the transmission processing, transmit a GOP of the MPEG video data, which has not been transmitted in the relay processing at the time of the reception of the transmission request, from the connection unit toward the third communication device in synchronization with transmission of the GOP performed in the relay processing; and
in the request processing, transmit, as the partial-transmission request, a partial-data transmission request indicating that the third communication device is requesting a GOP of the MPEG video data, which has not been transmitted in the transmission processing at the time of the completion of the transmission processing, from the connection unit toward the first communication device or another communication device.

11. A relay device according to claim 1, wherein:
the connection unit is connected to another communication device which has the same content as the first communication device,
the control unit performs request processing of transmitting a partial-transmission request indicating that the third communication device is requesting a second section of the content, which has not been transmitted in the transmission processing at a time of completion of the transmission processing, from the connection unit toward another communication device.

12. A relay method used for a relay device connected to a first communication device, a second communication device, and a third communication device, comprising:
performing relay processing of transmitting, upon reception of a content transmitted from the first communication device toward the second communication device, the content toward the second communication device;
performing transmission processing of transmitting, during the relay processing, upon reception of a transmission request for the content, which has been transmitted from the third communication device, a first section of the content, which has not been transmitted in the relay processing at a time of the reception of the transmission request, toward the third communication device in synchronization with transmission of the first section performed in the relay processing.

13. A relay method according to claim 12, wherein:
a relay device is connected to another communication device which has the same content as the first communication device,
the relay method further comprises,
performing request processing of transmitting a partial-transmission request indicating that the third communication device is requesting a second section of the content, which has not been transmitted in the transmission processing at a time of completion of the transmission processing, toward one of the first communication device and another communication device.

14. A relay method according to claim 12, wherein:
the content comprises MPEG video data;
the relay device comprises storage means; and
the relay method further comprises:
storing, in the storage means, a header portion of a sequence layer of the MPEG video data which has been received; and
performing, as the transmission processing, processing of transmitting, upon the reception of the transmission request during the relay processing, the header portion of the sequence layer stored within the storage means toward the third communication device, and subsequently transmitting the first section toward the third communication device in synchronization with the transmission of the first section performed in the relay processing.

15. A relay method according to claim 13, wherein:
the content comprises MPEG video data;
the relay device comprises storage means; and
the relay method further comprises:
storing, in the storage means, a header portion of a sequence layer of the MPEG video data which has been received; and
performing, as the transmission processing, processing of transmitting, upon the reception of the transmission request during the relay processing, the header portion of the sequence layer stored within the storage means toward the third communication device, and subsequently transmitting the first section toward the third communication device in synchronization with the transmission of the first section performed in the relay processing.

16. A relay method according to claim 14, further comprising deleting the header portion of the sequence layer stored within the storage means after completion of both the relay processing and the transmission processing.

17. A relay method according to claim 15, further comprising deleting the header portion of the sequence layer stored within the storage means after completion of both the relay processing and the transmission processing.

18. A relay method according to claim 14, wherein:
the transmission processing comprises transmitting, toward the third communication device, a GOP of the MPEG video data, which has not been transmitted in the relay processing at the time of the reception of the transmission request, in synchronization with transmission of the GOP performed in the relay processing; and
the request processing comprises transmitting, as the partial-transmission request, a partial-data transmission request indicating that the third communication device is requesting a GOP of the MPEG video data, which has not been transmitted in the transmission processing at the time of the completion of the transmission processing, toward the first communication device or another communication device.

19. A relay method according to claim 15, wherein:
the transmission processing comprises transmitting, toward the third communication device, a GOP of the MPEG video data, which has not been transmitted in the relay processing at the time of the reception of the transmission request, in synchronization with transmission of the GOP performed in the relay processing; and
the request processing comprises transmitting, as the partial-transmission request, a partial-data transmission request indicating that the third communication device is requesting a GOP of the MPEG video data, which has not been transmitted in the transmission processing at the time of the completion of the transmission processing, toward the first communication device or another communication device.

20. A relay method according to claim 16, wherein:
the transmission processing comprises transmitting, toward the third communication device, a GOP of the MPEG video data, which has not been transmitted in the relay processing at the time of the reception of the transmission request, in synchronization with transmission of the GOP performed in the relay processing; and
the request processing comprises transmitting, as the partial-transmission request, a partial-data transmission request indicating that the third communication device is requesting a GOP of the MPEG video data, which has not been transmitted in the transmission processing at the time of the completion of the transmission processing, toward the first communication device or another communication device.

21. A relay method according to claim 17, wherein:
the transmission processing comprises transmitting, toward the third communication device, a GOP of the MPEG video data, which has not been transmitted in the relay processing at the time of the reception of the transmission request, in synchronization with transmission of the GOP performed in the relay processing; and
the request processing comprises transmitting, as the partial-transmission request, a partial-data transmission request indicating that the third communication device is requesting a GOP of the MPEG video data, which has not been transmitted in the transmission processing at the time of the completion of the transmission processing, toward the first communication device or another communication device.

22. A relay method according to claim 12, wherein:
a relay device is connected to another communication device which has the same content as the first communication device,
the relay method further comprises,
performing request processing of transmitting a partial-transmission request indicating that the third communication device is requesting a second section of the content, which has not been transmitted in the transmission processing at a time of completion of the transmission processing, toward one of the first communication device and another communication device.

23. A program for causing a computer connected to a first communication device, a second communication device, and a third communication device to execute:
a relay step of transmitting, upon reception of a content transmitted from the first communication device toward the second communication device, the content toward the second communication device;
a transmission step of transmitting, during the relay step, upon reception of a transmission request for the content, which has been transmitted from the third communication device toward the first communication device, a first section of the content, which has not been transmitted in the relay step at a time of the reception of the transmission request, toward the third communication device in synchronization with transmission of the first section performed in the relay step.

24. A program according to claim 23, wherein:
the relay method further comprises,
the program further causes the computer to execute:
a request step of transmitting a partial-transmission request indicating that the third communication device is requesting a second section of the content, which has not been transmitted in the transmission step at a time of completion of the transmission step, toward the first communication device.

25. A program according to claim 24, wherein:
the content comprises MPEG video data;
the computer comprises storage means; and
the program further causes the computer to execute:
a storage step of storing, in the storage means, a header portion of a sequence layer of the MPEG video data which has been received; and
upon the reception of the transmission request during the relay step, as the transmission step, processing of transmitting the header portion of the sequence layer stored within the storage means toward the third communication device, and subsequently transmitting the first section toward the third communication device in synchronization with the transmission of the first section performed in the relay step.

26. A program according to claim 23, wherein:
a relay device is connected to another communication device which has the same content as the first communication device,
the relay method further comprises,
the program further causes the computer to execute:
a request step of transmitting a partial-transmission request indicating that the third communication device is requesting a second section of the content, which has not been transmitted in the transmission step at a time of completion of the transmission step, toward another communication device.
